(19) United States
(12) Patent Application Publication
(10) Pub. No.: US 2007/0152191 A1
(43) Pub. Date: Jul. 5, 2007

(54) Corrosion inhibitors

(76) Inventors: David O. Trahan, Lafayette, LA (US); Joseph M. Neathamer JR., Gretna, LA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 11/323,838

(22) Filed: Dec. 29, 2005

(51) Int. Cl. C09K 3/00

(52) U.S. Cl. 252/388

(57) ABSTRACT

In general the current invention relates to corrosion inhibitors useful in water-based (aqueous) heat transfer fluids. More particularly, the present invention can be used for protecting ferrous and non-ferrous metal surfaces used in the construction of water-based (aqueous) heat transfer systems such as engine blocks and radiators. The invention particularly applies to a blend of corrosion inhibiting agents that can be added to water or water-glycol or other suitable liquid in a circulating or static heat transfer system to protect metal surfaces from corrosion attack. When used in an aqueous solution the unique blend of corrosion inhibiting agents provides flash corrosion protection of ferrous and non-ferrous surfaces during operation and after the treated aqueous fluid is drained away provides atmospheric corrosion protection of the ferrous and non-ferrous surfaces. The invention further relates to a variety of other practical and industrial applications such as engine coolant corrosion inhibition, dyno fluid corrosion inhibition, and metal working corrosion inhibition applications. The corrosion inhibitor includes several components 1) a dicarboxylic acid component comprising decanedoic and dodecanedoic and one or more C10-C12 dicarboxylic acids or salts of these acids, 2) an oxyalkylated carboxylate imidazoline preferably produced from carboxylate fatty acid and amine, 3) organophosphonic acid or amine salts of the organophosphonic acid and 4) a secondary or tertiary alkanolamine organic acid salting agent. The corrosion inhibitors of the present invention provide improved corrosion protection as compared to conventional inhibitors and provide surprisingly improved corrosion protection as compared to inhibitors containing only a single mono-carboxylic acid or blend of monocarboxylic and dicarboxylic acids or salts of these acids. The corrosion inhibitor of the present invention preferably contains no nitrite, nitrate, or silicate salts.

### CROSS-REFERENCE TO RELATED APPLICATIONS

Priority of our U.S. Provisional Patent Application Ser. No. 60/640,002,filed 29 Dec. 2004, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to corrosion inhibitors useful in heat transfer fluids. More particularly, the present invention can be used for protecting ferrous and non-ferrous metal surfaces used in the construction of heat transfer systems such as engine blocks and radiators.

2. General Background of the Invention

Typically engines are tested at the point of manufacture with coolant in the engines. The coolant is then drained before the engines are shipped. Often, the engines arrive with corrosion damage due to the reaction of the residual coolant with the engine parts when exposed to air.

The following U.S. patents are incorporated herein by reference:
PAT. NO. Title
U.S. Pat. No. 6,299,655 Diesel fuel compositions
U.S. Pat. No. 4,959,160 Process for the treatment of contaminated emulsion
U.S. Pat. No. 4,493,780 Water-based hydraulic fluids having improved lubricity and corrosion inhibiting properties
U.S. Pat. No. 4,391,722 Water-based low foam hydraulic fluid employing 2-ethylhexanol defoamer U.S. Pat. No 4,390,439 Water-based hydraulic fluids having improved lubricity and corrosion inhibiting properties employing neodecanoic acid

### BRIEF SUMMARY OF THE INVENTION

The present invention is made from a unique blend of several functional components.
Component 1. A co-inhibitor component of the present invention that provides an organic acid such as decanoic and undecanoic or a C10 to C12 dicarboxylic acid is the Corfree M-1 product produced by Dupont Nylon. This co-inhibitor component is preferably blended into the concentrated product in a range of 1% to 40% as provided when made into a salt solution using a primary, secondary or tertiary amine and other amine compounds.
Component 2. A co-inhibitor component of the present invention that provides an ethoxylated imidazoline is the Aquaness Aminox 158 product produced by Baker Inteq. The product is preferably blended into the concentrated product in a range of 1% to 40% as provided. The Aminox 158 or equivalent product is a water soluble, oil dispersible, imidazoline derivative designed for the protection of ferrous metals exposed to corrosive water atmospheres. It is effective at low addition levels in hard water systems as a temporary preservative for metals. Aminox 158 or equivalent product is formulated to provide a high degree of detergency as well as rapid film forming characteristics. The product is capable of reversion to the amide, thus providing a pathway to degradability in effluent systems.
Component 3. A co-inhibitor component of the present invention that provides a polyphosphonic polymer is the Telomer C-Six product or equivalent. The active ingredient in this co-inhibitor component is formulated organophosphonate or polyaminophosphonate. The product is more effective in protecting metal surfaces than stabilized phosphates and all organic products used in water treatment products. This co-product is effective in the presence of low levels of chlorine (<5 parts per million) and also offers the additional benefit of copper alloy protection. This co-inhibitor product is preferably blended into the concentrated blend in a range of 1% to 40% as provided.
Component 4. A co-inhibitor component of the present invention that provides salting of free acid forms includes primary, secondary or tertiary amine compounds, including alone or in combination the following amines: monoethanolamine, diethanolamine, triethanolamine, aminoethylpiperazine, morpholine, methyl diethanolamine, aminoethylethanolamine. This co-inhibitor product is preferably blended into the concentrated inhibitor blend in a range of 5% to 40%.
Component 5. A defoaming component of the present invention that provides antifoaming properties include silicone based defoaming products such as a silicone oil that is approximately 12,500 centistokes in viscosity. Synonyms: silicone, all; silicones; Dimethylpolysiloxane hydrolyzate; alpha-Methyl-omega-methoxypolydimethylsiloxane; Polydimethyl silicone oil; Poly(dimethylsiloxane); Polydimethylsiloxane, methyl end-blocked; Polyoxy(dimethylsilylene), alpha-(trimethylsilyl)-omega-hydroxy; Poly[oxy(dimethylsilylene)], alpha-[trimethylsilyl]-omega-[(trimethylsilyl)oxy]; Silicone oils; Siloxane and silicones, dimethyl; Siloxanes and silicones, dimethyl; alpha-(Trimethylsilyl)poly[oxy(dimethylsilylene)]-omega-methyl; Silicone oil. This defoamer product is preferably blended into the concentrated inhibitor blend in a range of 0. 1% to 1%.

A typical concentrated inhibitor blend would comprise: (all percentages are

| | | |
|---|---|---|
| 1. | Corfree M1 | 5% to 35% |
| 2. | Aminox 158 | 5% to 25% |
| 3. | Alkanolamine | 5% to 40% |
| 4. | C-Six | 1% to 10% |
| 5. | Silicone 12,500 | 0.1% to 1% |
| 6. | Water | 5% to 20% |

The concentrated inhibitor blend is preferably subsequently diluted to a diluted mixture of >0.05% with water for application in a metal protection application.

### DETAILED DESCRIPTION OF THE INVENTION

The present invention is made from a unique blend of several functional components.
Component 1. A co-inhibitor component of the present invention that provides an organic acid such as decanoic and undecanoic or a C 10 to C 12 dicarboxylic acid is the Corfree M-1 product produced by Dupont Nylon. This co-inhibitor component is preferably blended into the concentrated product in a range of 1% to 40% as provided when made into an alkanolamine salt solution using a primary, secondary or tertiary amine and other amine compounds.
Component 2. A co-inhibitor component of the present invention that provides an oxyalkylated carboxylate imidazoline is the Aquaness Aminox 158 product produced by Baker Inteq (the Aquaness Aminox 158 product comprises of a reacted product of a carboxylate imidazoline and ethylene oxide, approximately 40% by weight carboxylate imidazoline combined with 60% by weight ethylene oxide. The product is preferably blended into the concentrated product in a range of 1% to 40% as provided. The Aminox 158 or equivalent product is a water soluble, oil dispersible, imidazoline derivative designed for the protection of ferrous metals exposed to corrosive water atmospheres. It is effective at low addition levels in hard water systems as a temporary preservative for metals. Aminox 158 or equivalent product is formulated to provide a high degree of detergency as well as rapid film forming characteristics. The product is capable of reversion to the amide, thus providing a pathway to degradability in effluent systems.
Component 3. A co-inhibitor component of the present invention that provides a polyphosphonic polymer is the Telomer C-Six product or equivalent. The active ingredient in this co-inhibitor component is formulated organophosphonate or polyaminophosphonate. The product is more effective in protecting metal surfaces than stabilized phosphates and all organic products used in water treatment products. This co-product is effective in the presence of low levels of chlorine (<5 parts per million) and also offers the additional benefit of copper alloy protection. This co-inhibitor product is preferably blended into the concentrated blend in a range of 1 % to 40% as provided. Component 4. A co-inhibitor component of the present invention that provides salting of free acid forms includes primary, secondary or tertiary amine compounds, including alone or in combination the following amines: monoethanolamine, diethanolamine, triethanolamine, aminoethylpiperazine, morpholine, methyl diethanolamine, aminoethylethanolamine. This co-inhibitor product is preferably blended into the concentrated inhibitor blend in a range of 5% to 40%.
Component 5. A defoaming component of the present invention that provides antifoaming properties include silicone based defoaming products such as a silicone oil that is approximately 12,500 centistokes in viscosity. Synonyms: silicone, all; silicones; Dimethylpolysiloxane hydrolyzate; alpha-Methyl-omega-methoxypolydimethylsiloxane; Polydimethyl silicone oil; Poly(dimethylsiloxane); Polydimethylsiloxane, methyl end-blocked; Polyoxy(dimethylsilylene), alpha-(trimethylsilyl)-omega-hydroxy; Poly[oxy(dimethylsilylene)], alpha-[trimethylsilyl]-omega-[(trimethylsilyl)oxy]; Silicone oils; Siloxane and silicones, dimethyl; Siloxanes and silicones, dimethyl; alpha-(Trimethylsilyl)poly[oxy(dimethylsilylene)]-omega-methyl; Silicone oil. This defoamer product is preferably blended into the concentrated inhibitor blend in a range of 0. 1% to 1%.

A typical concentrated inhibitor blend would comprise: (all percentages are based on a weight basis)

| | | |
|---|---|---|
| 1. | Corfree M1 | 5% to 35% |
| 2. | Aminox 158 | 5% to 25% |
| 3. | Akanolamine | 5% to 40% |
| 4. | C-Six | 1% to 10% |
| 5. | Silicone 12,500 | 0.1% to 1% |
| 6. | Water | 5% to 20% |

The concentrated inhibitor blend is preferably subsequently diluted to a diluted mixture of >0.1% with water or water/glycol solutions for application in a metal protection application.

Set out below is the preferred embodiment of concentrate of the present invention, which is preferably blended with water or a water/glycol solution and diluted to preferably >0. 1%, more preferably >0.5%, most preferably >2.5%, and >5.0%, for example.

| Component (preferred | | |
|---|---|---|
| product) | Function | Percentage by Weight |
| 1. Dicarboxylate (Corfree | co-inhibitor | Preferably about 1% to |
| M1) | | 40%. More preferably |
| | | about 5% to 35%. Most |
| | | Preferably about 15% to |
| | | about 20%, for example |
| 2. Oxyalklyated | co-inhibitor | Preferably about 1% to |
| Carboxylate Imidazoline | | 40%. More preferably |
| (Aminox 158) | | about 10% to 35%. Most |
| | | Preferably about 25% to |
| | | about 30%, for example |
| 3. Alkanolamine | co-inhibitor | Preferably about 1% to |
| (Triethanolamine) | | 45%. More preferably |
| | | about 20% to 40% |
| | | Most Preferably about |
| | | 35% to 40%, for example |
| 4. Organophosphonate | co-inhibitor | Preferably about 1% to |
| (C-Six) | | 15%. More preferably |
| | | about 4% to 10%. Most |
| | | Preferably about 5% to |
| | | 7%, for example |
| 5. Defoamer (Silicone | antifoaming | Preferably about 0.1% to |
| 12,500) | | 1.5%. More preferably |
| | | about 0.2% to 1.0%. Most |
| | | Preferably about 0.5% to |
| | | 0.7%, for example |
| 6. Diluent (deionized | diluent | Preferably about 2% to |
| water) | | 15%. More preferably |
| | | about 5% to 12.5%. Most |
| | | Preferably about 8% to |
| | | 10%, for example |

An example of a concentrated formulation of the present invention which is commercially available as CPro 225™ Blend from Rapid Group, L.L.C. of 1424 S. Hugh Wallis Road, Lafayette, La. 70508, U.S., is set out below (where percentages are by weight):

| | | | | |
|---|---|---|---|---|
| 1. | Aminox 158 (or equal) | 29.4% | 142.6 | lbs (64.68 kg) |
| 2. | Dupont CorFree M1 | 17.3% | 83.9 | lbs (38.1 kg) |
| 3. | TEA 85% | 37.4% | 181.4 | lbs (82.28 kg) |
| 4. | Silicone, 12500 cstk | 0.5% | 2.4 | lbs (1.1 kg) |
| 5. | Dow Versenex CSI | 6.0% | 29.10 | lbs (13.2 kg) |
| 6. | Water | 9.4% | 45.6 | lbs (20.7 kg) |

8.8 lb/gal (0.88 kg/l) (estimate), 485 lb/drum (220.0 kg/250 l).

This concentrated formulation can be added to water and diluted to >0.2% before being used as a corrosion and scale inhibitor in a diesel truck engine, for example.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

claims:

1. A corrosion inhibitor concentrate, comprising:
a diluent;
active ingredients present in the following amount by weight:
(a) about 1-40% dicarboxylic acid component;
(b) about 1-40% oxyalkylated carboxylate imidazoline component;
(c) about 1-40% organophosphonate component;
(d) about 1-40% alkanolamine component; and
(e) about 0.1 to 1% defoaming component.

2. The corrosion inhibitor concentrate of claim 1, wherein the diluent is present in an amount of about 2-15% by weight, and the active ingredients are present in an amount of about 85-98% by weight.

3. The corrosion inhibitor concentrate of claim 2, wherein the diluent is present in an amount of about 5-12.5% by weight, and the active ingredients are present in an amount of about 87.5-95% by weight.

4. The corrosion inhibitor concentrate of claim 3, wherein the diluent is present in an amount of about 8-10% by weight, and the active ingredients are present in an amount of about 90-92% by weight.

5. The corrosion inhibitor concentrate of any one of claims 1-4, wherein:
(a) the carboxylic acid component comprises at least one acid component from the group consisting of:
decanoic and undecanoic acid;
at least one dicarboxylic acid having between 10 and 12 carbon atoms or a salt thereof;
a combination of decanedoic and dodecanedoic acid;
(b) the oxyalkylated carboxylate imidazoline component comprises a water soluble, oil dispersible, carboxylate imidazoline derivative designed for the protection of ferrous metals exposed to corrosive water atmospheres;
(c) the organophosphonate component comprises formulated polyaminophosphonate designed to provide corrosion protection of ferrous metals exposed to corrosive water solutions and prevent mineral scale from depositing on heat transfer surfaces;
(d) the alkanolamine component comprises primary, secondary or tertiary amine compounds; and
(e) the defoaming component comprises silicone.

6. The corrosion inhibitor concentrate of any one of claims 1-5, wherein:
(d) the alkanolamine component comprises primary, secondary or tertiary amine compounds selected from the group consisting of monoethanolamine, diethanolamine, triethanolamine, aminoethylpiperazine, morpholine, methyl diethanolamine and aminoethylethanolamine.

7. The corrosion inhibitor concentrate of any one of claims 1-6, wherein:
(e) the defoaming component is selected from the group consisting of dimethylpolysiloxane hydrolyzate; alpha-methyl-omega methoxypolydimethylsiloxane, polydimethyl silicone oil; poly (dimethylsiloxane); 5 polydimethylsiloxane, methyl end-blocked; polyoxy (dimethylsilylene), alpha-(trimethylsilyl)-omega-hydroxy; poly[oxy(dimethylsilylene)], alpha[trimethylsilyl]-omega-[(trimethylsilyl)oxy]; siloxanes and silicones, dimethyl; alpha-(trimethylsilyl)poly[oxy(dimethylsilylene)]-omega-methyl; and mixtures thereof.

8. The corrosion inhibitor concentrate of any one of claims 1 and 5-7, wherein:
the diluent is present in an amount of 2-15% by weight;
the active ingredients are present in the following amount by weight:
(a) about 15-20% dicarboxylic acid component;
(b) about 25-30% oxyalkylated carboxylate imidazoline component;
(c) about 5-7% organophosphonate component;
(d) about 35-40% alkanolamine component; and
(e) about 0.5-0.7% defoaming component.

9. The corrosion inhibitor concentrate of claim 8, wherein:
the diluent is present in an amount of 5-12.5% by weight;
the active ingredients are present in the following amount by weight:
(a) about 15-20% dicarboxylic acid component;
(b) about 25-30% oxyalkylated carboxylate imidazoline component;
(c) about 5-7% organophosphonate component;
(d) about 35-40% alkanolamine component; and
(e) about 0.5-0.7% defoaming component.

10. The corrosion inhibitor concentrate of claim 9, wherein:
the diluent is present in an amount of 8-10% by weight;
the active ingredients are present in the following amount by weight:
(a) about 15-20% dicarboxylic acid component;
(b) about 25-30% oxyalkylated carboxylate imidazoline component;
(c) about 5-7% organophosphonate component;
(d) about 35-40% alkanolamine component; and
(e) about 0.5-0.7% defoaming component.

11. A corrosion inhibitor comprising:
a water or water/glycol solution including 0.05-5.0% by weight of the corrosion inhibitor concentrate of any prior claim.

12. A corrosion inhibitor comprising:
a water or water/glycol solution including at least 0.05% by weight of the corrosion inhibitor concentrate of any prior claim.

13. A corrosion inhibitor comprising:
a water or water/glycol solution including at least 0.1% by weight of the corrosion inhibitor concentrate of any prior claim.

14. A corrosion inhibitor comprising:
a water or water/glycol solution including at least 0.5% by weight of the corrosion inhibitor concentrate of any prior claim.

15. A corrosion inhibitor comprising:
a water or water/glycol solution including at least 2.5% by weight of the corrosion inhibitor concentrate of any prior claim.

16. A corrosion inhibitor comprising:
a water or water/glycol solution including at least 5.0% by weight of the corrosion inhibitor concentrate of any prior claim.

17. The invention(s) substantially as shown and/or described herein.
